(19) United States
(12) Patent Application Publication
(10) Pub. No.: US 2002/0135477 A1
(43) Pub. Date: Sep. 26, 2002

(54) Locking system for securing a loaded handgun

(76) Inventors: Christopher J. Dabrowski, Seattle, WA (US); Keith S. Willows, Seattle, WA (US); Stephen H. Smith, Clinton, WA (US)

Correspondence Address: LAW OFFICES OF RONALD M ANDERSON, 600 108TH AVE, NE, SUITE 507, BELLEVUE, WA, 98004, US

(21) Appl. No.: 09/813,511

(22) Filed: Mar. 20, 2001

(51) Int. Cl. E05B 45/06

(52) U.S. Cl. 340/542

(57) ABSTRACT

A locking system for a loaded handgun that prevents the handgun from being removed from a housing until a combination lock is unlocked. The housing is constructed of a material such as steel or a high impact resistance polymer, capable of preventing penetration of a slug fired by the handgun. The combination lock is either an illuminated keypad or a bio-metric sensor. In one embodiment, the combination lock actuates a locking member that prevents the handgun from being removed and extends behind the trigger, so that the handgun cannot be fired. In another embodiment, the combination lock secures a locking member in a position that prevents a holster containing the handgun from being pivoted outside an internal cavity within the housing. While the handgun and holster are locked inside the internal cavity, the handgun cannot be withdrawn from the holster. When the proper combination is entered, the locking member releases the holster, and a spring element pivots the holster free of the internal cavity. Mounting hardware and any ammunition that is stored within the housing can only be accessed when the combination lock is unlocked and the handgun is removed.

### FIELD OF THE INVENTION

This invention generally relates to a locking device for securing a handgun, and more specifically, to locking devices in which a handgun is stored in a manner so that it is not accessible by unauthorized persons.

### BACKGROUND OF THE INVENTION

A significant portion of the shooting incidents that occur each year involve a child or other person gaining unauthorized access to a handgun. In a study conducted by the Center to Prevent Handgun Violence (CPHV), 137 incidents of handgun violence were analyzed. These 137 incidents involved young people of all ages, as either victims or offenders. The incidents studied occurred during the 1997/98 school year and occurred in various environments, including homes and schools. While the study was neither a complete survey of all incidents involving handguns and children, nor a random sample of all such incidents, it provides confirmation that unauthorized access to handguns often plays a role in these incidents. In many of these incidents, the handguns involved belonged to a family member or to friend of the shooter.

Based on this study, the CPHV concluded that at least 53% of the incidents of handgun violence involving children studied (73/137) could have been prevented if the handguns had been properly secured. The following details about the shootings included in this report may help clarify the findings. In nearly half of these incidents (62/137), the handgun belonged to a family member, a relative, or a friend of the shooter. These findings are consistent with a recently released National Institute of Justice study, which asked a national sample of male high school sophomores and juniors about their experiences with handguns. Respondents said that family members and friends were the primary sources of handguns. The National Institute of Justice study further concluded that unintentional or accidental shootings involving children number over 8,700 per year. Of these 8,700 shootings, over 34% involved handguns that were unsecured. It is significant to note that gunshot wounds are the second leading cause of death for the 10-year-old to 34-year-old age group.

The motives for the incidents studied by the CPHV varied. In almost half of the incidents (65/137), the handgun was fired unintentionally. The most common type of shooting reported overall (38% or 52/137) occurred because the shooter was playing with the handgun. Only about one third of the incidents (52/137) involved any actual intent to commit harm. CPHV examined the circumstances of all 137 incidents and evaluated the impact that several different safety measures might have had in preventing them. In common with a report by the U.S. Department of Health and Human Services, “Healthy People 2000,” which concluded that “many injuries might be prevented if immediate access to lethal weapons was reduced, in particular through appropriate storage of handguns,” CPHV determined that at least 53% of the incidents (73/137) identified as a part of this report could have been prevented if the handgun owner had properly secured the weapon by locking it away (preferably unloaded and separate from the ammunition). CPHV also found that a minimum of 48% (66/137) of incidents could have been prevented if a trigger lock (a lock which immobilizes the trigger) had been placed on the handgun.

Clearly, these findings support a conclusion that at least some handgun violence and accidental injuries caused by handguns are preventable, namely by encouraging handgun owners to lock up, or otherwise secure, handguns in homes where children live or visit. Although handgun safes and trigger locks are well known, they are not yet widely enough used to prevent the type of incidents studied above. Also, because one significant reason for keeping a handgun in the home is for use in providing protection, many handgun owners are reluctant to adopt handgun safety measures that limit access to those handguns when they might be needed, such as during an unauthorized night time entry by an intruder. Handgun owners fear that a device, which prevents unauthorized access to their handguns might also prevent authorized access at the very moment access to the handgun is most critically needed. Furthermore, while separately storing an unloaded handgun and ammunition may reduce the likelihood of accidental shootings by children, such storage also makes it difficult for an authorized person to use a loaded handgun in an emergency situation. Since a desire for personal and family protection in such an emergency situation is often one of the primary motivations for owning a handgun, storage of the handgun and ammunition in separate locations is often not acceptable to handgun owners.

It would be desirable to develop a system to secure a handgun, such that access is denied to an unauthorized person yet, can be immediately provided to an authorized person in an emergency situation. Such a system preferably would enable the handgun to be immediately used once it is properly accessed and removed from secure storage. Access of the handgun should be readily possible, even in a dark room. Furthermore, such a system should be able to be securable in a variety of locations, and should enable a handgun to be safely stored and secured while loaded with ammunition. The trigger should either be generally inaccessible or locked to prevent the handgun from being fired while secured in the storage system.

In U.S. Pat. No. 4,309,065 (Pappas), a handgun safe is described that uses a keyless lock to limit access to a handgun stored in the safe. Once opened, the butt of the handgun is readily accessible, enabling a “quick draw,” and the safe can be secured in a variety of different locations. However, the safe disclosed in this patent does not include means to enable the handgun owner to readily operate the lock in order to access a handgun stored in the safe, in a dark environment.

U.S. Pat. No. 5,111,755 (Rouse) describes a handgun safe that uses an illuminated keypad lock to limit access to the interior of the safe and the handgun stored therein. Once opened, an internal release mechanism must be manipulated to remove the handgun. Although not conventionally locked, the release is designed to be ergonomically difficult for a child to actuate. After the release is actuated, the butt of the handgun is readily accessible, enabling a “quick draw” (however, a delay is first incurred in unlocking the safe and then properly manipulating the release).

In U.S. Pat. No. 5,161,396 (Loeff), a handgun safe is described that incorporates tactile features enabling a handgun owner to readily obtain access even in a dark environment. However, when this handgun safe is opened, the handgun is not optimally positioned to enable a “quick draw.” Further, this prior art handgun safe is not readily secured in one location. Indeed, in the disclosed preferred embodiment, the handgun safe is readily portable.

U.S. Pat. No. 5,344,010 (Dyer), describes a handgun safe that is of particularly sturdy construction, to discourage the handgun safe from being “pried” open, or otherwise forcibly opened. However, the handgun safe disclosed in this patent does not enable the handgun owner to readily obtain access in a darkened environment, and does not enable a “quick draw” of the handgun.

In U.S. Pat. No. 5,416,826 (Butler), a handgun safe is described that incorporates a telephone circuit that can notify the police when the safe is opened - if an emergency opening sequence is used. The handgun safe incorporates a lighted keypad to facilitate night time use, but does not enable a “quick draw.” The handgun safe also includes an alarm feature to deter anyone from removing the safe to a different location, but is not secured to prevent such removal.

U.S. Pat. No. 5,901,589 (Cordero) describes a handgun safe that incorporates a “secret” opening procedure, intended to prevent access to a handgun stored therein, even if an unauthorized individual obtains a key to the handgun safe. In a safe mode, both the key and the “secret” opening procedure are required for entry. In a less secure access mode, the key is not required, and only the “secret” operating procedure must be used, thus, enabling an authorized user more rapid access to a handgun. The handgun safe is designed to be securely mounted to prevent the safe from being removed from the owner's premises and is nominally designed to facilitate a “quick draw.” However, a user must reach into the safe, maneuver a hand around mounting brackets to grip the handgun, and then withdraw the handgun from the safe.

### SUMMARY OF THE INVENTION

In accord with the present invention, a system for locking a loaded handgun is defined. All embodiments of the present invention incorporate a housing having an interior, combination lock, and a locking member that prevents the handgun from being removed from the housing. A separately lockable cover may be included, but is not required. Mounting means and any ammunition stored within the interior are disposed so that they can only be accessed when the handgun is unlocked and removed from the housing.

In one embodiment, the combination lock includes a keypad and opens when a predefined sequence of keystrokes is entered on the keypad. The keypad can selectively be operated in either a night mode or a day mode. The day mode requires that the predefined sequence of keystrokes be entered on the keypad within a predetermined time period. In the night mode, a first portion of the predefined sequence of keystrokes are initially entered when the night mode is selected, and then only a second portion of the predefined sequence of keystrokes needs to be entered on the keypad if the user subsequently wants to access the handgun, e.g., during the night. Preferably, the night mode reverts to the day mode after a predetermined time interval, for example, after daybreak. In a preferred form of this embodiment, the first portion of the predefined sequence of keystrokes entered when the night mode is selected includes all but the last two keystrokes of the predefined sequence, so that only these last two keystrokes must be entered on the keypad to unlock the handgun.

In another embodiment, the combination lock includes a bio-metric sensor, and a verification of an individual's right to access the handgun by a personal biological characteristic, such as a fingerprint, a palm print, or a hand print, is required to access the handgun.

Any of the embodiments of the present invention can include an alarm unit operatively connected to the combination lock. When in an alarm mode, if the combination lock is unlocked, the alarm unit triggers a remote alarm, indicating an emergency situation is in progress. For example, the alarm unit can be connected to a home security system, such that when the combination locking means is unlocked, the alarm unit causes the home security system to send a signal indicative of the emergency situation to a monitoring service. Alternatively, the alarm unit can include a telephone line to connect to an emergency services telephone number, such that when the combination lock is unlocked, the alarm unit dials the emergency services telephone number to notify the emergency service of the emergency situation. The alarm unit can also include a voice recording, so that when the emergency services telephone number is answered, the voice recording is transmitted to the emergency service to describe the nature of the emergency, indicating that the handgun has been accessed.

One embodiment of the present invention includes a handgun support secured within the interior of the housing. The support has an opening into which a handgun is inserted, such that a handle of the handgun is accessible to be readily gripped, yet the structure of the handgun support and its disposition within the housing renders the trigger mechanism and the barrel of the handgun inaccessible and prevents the handgun being removed. A locking member is positioned within the interior, and is selectively movable between a locked position that prevents the handgun from being withdrawn from the handgun support, and an unlocked position that permits the handgun to be withdrawn from the handgun support. The combination lock is contained within the housing; when the combination lock is in a locked position, the locking member cannot be moved from its locked position to its unlocked position until the predefined sequence of keystrokes is entered on the keypad.

The locking member can be moved from the unlocked position to the locked position using a lever that can be manually manipulated. Preferably, in this embodiment, the locking member comprises an elongate bar coupled with a spring element. The spring element is compressed when the locking member is in the locked position. When the combination lock is unlocked, the spring element applies a bias force that moves the locking member to the unlocked position, enabling the handgun to be withdrawn. Also, when in the locked position, the locking member is preferably disposed behind a trigger of the handgun, thus preventing the trigger from being moved to a firing position, as well as preventing the handgun from being removed from the handgun support. The locking member is significantly stronger than the trigger, and any attempt to forcibly remove the handgun from the handgun support when the locking member is in its locked position will destroy the trigger, disabling the handgun.

An ejection slide included in another embodiment is used to prevent the locking member from being moved in front of the trigger as the user inserts the handgun into the handgun support. A spring element is coupled to the ejection slide and is compressed as the handgun is fully seated in the handgun support. Once the handgun is fully seated, the ejection slide is disposed such that the locking member can be moved from its unlocked position to its locked position, behind the trigger. When the handgun is less than fully inserted into the handgun support, the ejection slide physically blocks the locking member, and the locking member is prevented from moving in front of the trigger. When the combination lock is unlocked, the locking member is moved from its locked position, and as the handgun is removed from the handgun support, the spring element provides a biasing force that at least partially ejects the handgun from within the handgun support, so that the handgun can be more quickly removed from the locking system by the user. The spring element preferably comprises a helical spring.

Another embodiment includes a plate that separates the housing into an upper section and a lower section. When the handgun is unlocked and removed, the plate can be moved to allow access to the lower section. In yet another embodiment, a housing includes a lip that extends upwardly beyond the handgun support to prevent an ammunition clip in the handle of the handgun from being removed while the handgun is locked in the handgun support.

A cover may be pivotally connected to the housing, such that when the cover is in a closed position, access to the interior is precluded; and when the cover is in an open position, access to the interior is enabled. Within the interior of the housing of one embodiment is a holster. The holster is selectively moveable between a first position in which the holster is disposed within an interior cavity of the housing that is sized disposed so as to prevent the handgun from being removed from the holster, and a second position in which a handle of the handgun is readily accessible to be gripped by a user for removal from the holster. When in a locked position, the locking member prevents the holster from being moved to the second position until the combination lock is unlocked.

Preferably, this and other related embodiments include a spring element that is connected to the holster. When the holster is in the first position, the spring is compressed. When the combination lock is unlocked, so that the locking member no longer prevents the holster from moving to the second position, the bias force of the spring element automatically causes the holster to move to its second position.

The holster includes an elastomeric insert that is sized and shaped to receive and protect the handgun. Preferably, the holster itself is fabricated from a structurally strong material so that the handgun cannot be accessed by breaking the holster. The insert may be fabricated in a plurality of different forms to accept different makes and models of handguns.

### BRIEF DESCRIPTION OF THE DRAWING Figures

The foregoing aspects and many of the attendant advantages of this invention will become more readily appreciated as the same becomes better understood by reference to the following detailed description, when taken in conjunction with the accompanying drawings, wherein:

FIG. 1 is an isometric view that shows selected interior details of a first embodiment of a handgun locking device, which is particularly suitable for mounting on a horizontal surface;

FIG. 2 is an isometric view of a second embodiment of a handgun locking device suitable for mounting on horizontal surface, differing from the first embodiment most significantly by the addition of a separately lockable cover and by the position of the handgun when secured;

FIG. 3 is an isometric view of a handgun support and locking mechanism suitable for use in either the embodiment of FIG. 1 or the embodiment of FIG. 2;

FIGS. 4A-4D are schematic side elevational views providing details of the operation of the latch mechanism of FIG. 3;

FIG. 5 is an isometric view of the handgun support and locking mechanism of FIG. 3, from a different viewpoint;

FIG. 6 is an isometric view of another embodiment of a handgun support and locking mechanism suitable for use in either the embodiment of FIG. 1 or FIG. 2; illustrating the locking mechanism in an unlocked state;

FIG. 7 is an isometric view of the handgun support and locking mechanism of FIG. 6, illustrating the locking mechanism in a locked state;

FIG. 8 is an isometric view of the a handgun support and locking mechanism of FIG. 7 from a different viewpoint, showing details of a ejection slide that prevents accidental discharge of the handgun;

FIG. 9 is an isometric view of an embodiment of a handgun locking device suitable for mounting on a vertical surface, shown with a lockable cover in a closed position;

FIG. 10 is an isometric view of the handgun locking device of FIG. 9, shown with the lockable cover in an open position, and a holster in which a handgun is secured, in a locked position;

FIG. 11 is an isometric view of the handgun locking device of FIG. 9, with the lockable cover in an open position, and the holster in an unlocked position;

FIGS. 12A-12B are schematic views of the interior locking mechanism; and

FIGS. 13A-13B are front elevational views illustrating details of how the interior locking mechanisms of FIGS. 12A-12B are disposed within the embodiment of the handgun locking device shown in FIG. 9.

### DESCRIPTION OF THE PREFERRED EMBODIMENT

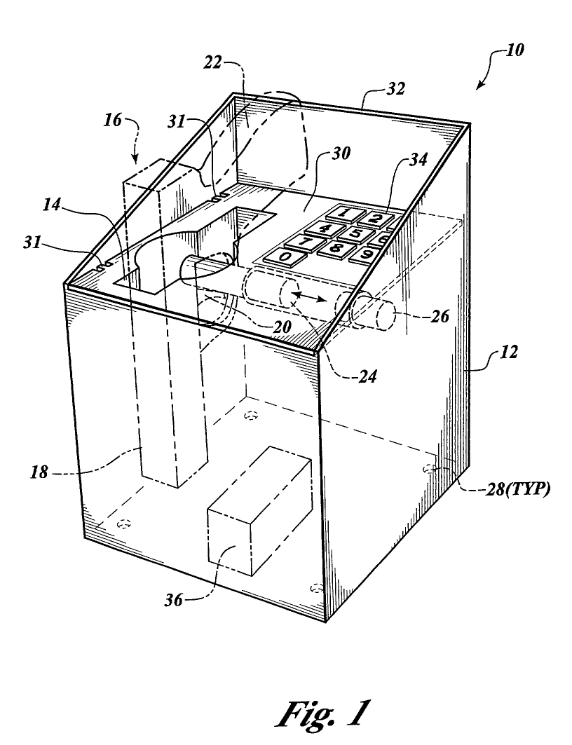

In accord with the present invention, a handgun locking system is defined. Various embodiments are envisioned, but these embodiments fall into two general categories, including a first group more suited to be mounted on a horizontal surface, such as on or inset into a floor, or other surface, and a second group more suited to be mounted on a vertical surface, such as on or within a wall. FIGS. 1-8 illustrate embodiments of the first group, while FIGS. 9-13 illustrate embodiments in the second group.

In FIG. 1, a first embodiment of a handgun locking device 10 is illustrated that includes a housing 12. A handgun 16 is inserted into an opening 14 in housing 12. When handgun 16 is fully inserted into opening 14, a barrel 18 of handgun 16, and a trigger 20 of handgun 16 are concealed from view and inaccessible, while a handle 22 of handgun 16 remains readily accessible. Once handgun 16 has been inserted into opening 14 of housing 12, a locking member 24 is moved behind trigger 20. When locking member 24 is so positioned, handgun 16 cannot be removed from housing 12. Preferably, locking member 24 is stronger than trigger 20, such that if someone were to attempt to forcibly remove handgun 16 from housing 12, trigger 20 would fail and likely break before locking member 24 fails. Also, any trigger guard provided on the handgun would further be engaged by the locking member, preventing the handgun from being removed from opening 14. Thus, if someone attempted to forcibly remove handgun 16 from housing 12, in doing so trigger 20 would likely be destroyed and the handgun rendered inoperable, and the locking member catching on a trigger guard might still prevent the handgun from being removed.

Housing 12 includes an upper plate 30 in which opening 14 is formed. Upper plate 30 provides a mounting surface for a keypad 34. Preferably, an electrical or mechanical keypad type locking mechanism is used to secure locking member 24 in a locked position, although a different type of locking mechanism could be used, such as a dial type lock or a key lock; however, the latter types of locking mechanisms can be difficult to actuate in an emergency situation.

Preferably, the locking mechanism used in the present invention should be easily and rapidly actuatable, especially in an emergency situation. Locking device 10 is particularly well adapted to be unlocked quickly in an emergency situation for a number of reasons. Also, handle 22 of the handgun is readily accessible, even when the device is locked. Handle 22 is positioned such that it can be easily grasped, and as soon as locking member 24 is moved from the locked position to an unlocked position, the handgun can be immediately withdrawn from housing 12. Keypad 34 is simple, easy to use, and can be unlocked quickly, while still affording a significant amount of security. For example, even a four-digit security code has over 9,999 different possible combinations. It is envisioned that handgun locking device 10 may need to be accessed in an emergency situation and possibly at night. Preferably, keypad 34 is illuminated using either a battery power source or by connection to an alternating current (AC) power supply energized through AC line power, so that the combination can quickly be entered on the keypad even in a dark environment. If a battery power source is used to illuminate the keypad, it can be activated with a separate switch or when the user activates any key on the keypad.

Handgun locking device 10 is also particularly well suited to store a loaded handgun without risk of accidental discharge of a round. Housing 12 is preferably fabricated from a material to withstand penetration by a slug fired from handgun 16, in the event that the handgun is discharged while inside the housing. To achieve this capability, housing 12 is preferably fabricated of a heavy gauge steel, or the housing is alternatively lined with a bullet resistant material, such as a fiber reinforced polymer or a composite material, as are well known in the art. Such polymers are available under a variety of different trade names, such as KEVLAR™. In general, these polymers include aramid fibers, though other polymers are also suitable. As noted above, when handgun 16 is secured within housing 12 and locking member 24 is in the locked position, not only can the handgun not be removed from the housing, but also, the trigger cannot be actuated. Plate 30 physically prevents access to trigger 20. Even if an individual had fingers that were long and slim enough to be able to pass through opening 14 and around handgun 16 to access trigger 20, the handgun can still not be fired when locking member 24 is in the locked position. It should be also noted that housing 12 incorporates a back plate 32. Back plate 32 extends upwardly least as high as the middle of the end of handle 22 on handgun 16 and is disposed sufficiently close to the butt of handle 22 to prevent removal of an ammunition clip from the handle, if handgun 16 is of the type that has an ammunition clip. Back plate 32 thus prevents access to an ammunition clip in the butt of the handgun, thereby preventing handgun 16 from being unloaded (or loaded—if not already loaded) without unlocking handgun locking device 10 and removing handgun 16 from housing 12.

With reference to FIG. 1, it will be apparent how plate 30 can be pivoted open, outwardly from housing 12, when handgun 16 has been unlocked and removed from handgun locking device 10. Once the handgun has been removed, a locking pin 26 can be moved to an unlocked position so that plate 30 can be opened. Plate 30 is pivotally secured to housing 12 by hinges 31, which are disposed at one side of the plate so that the hinges are inaccessible when the plate is secured within the housing. With handgun 16 removed, and locking pin 26 in an unlocked position, plate 30 can be pivoted open to provide access to the interior volume of housing 12. It is envisioned that the interior volume of housing 12 be employed to store one or more boxes of ammunition 36. The interior volume of housing 12 cannot be accessed and ammunition 36 is secured when: (a) plate 30 is in the closed position; (b) locking pin 26 is in the locked position; (c) handgun 16 is inserted into the housing 12; and, (d) locking member 24 is in the locked position. Preferably, a plurality of mounting holes 28 used to securely attach housing 12 to an underlying support surface (not shown) are accessible only after plate 30 has been pivoted open, preventing the housing from being removed from the surface to which it is attached while the handgun is secured within it. It is envisioned that lag bolts can be used to securely attach handgun locking device 10 to the floor or sub-floor of a room in which handgun locking device 10 is stored. Because access to mounting holes 28 is only enabled when handgun 16 is unlocked and removed from housing 12, an intruder would not be able to readily remove handgun locking device 10 from the room in which it is secured. Frequently, intruders or thieves will attempt to steal handgun safes and take them to a different location to attempt to remove the handgun at a later time. At such a location, the thief or intruder may have access to tools that could be used to break into a handgun safe, but which are not readily portable or practical to use during a theft.

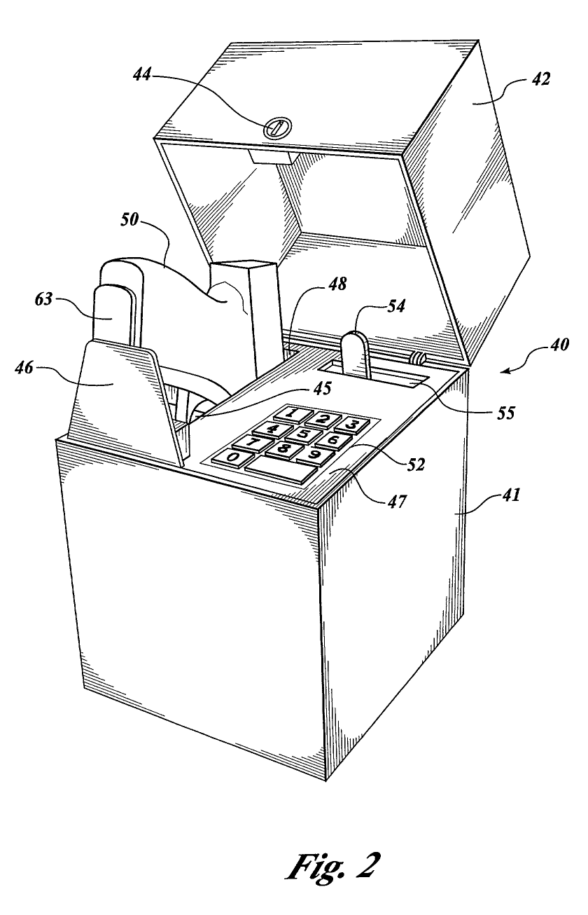

FIG. 2 illustrates an alternate embodiment of a handgun locking device 40 that is also best secured to a horizontal surface. The most readily apparent difference between handgun locking device 40 and handgun locking device 10 is that handgun locking device 40 incorporates a separately lockable cover 42. As illustrated, cover 42 includes a generally conventional key-actuated lock 44. It is envisioned that cover 42 will be left in the closed and locked position when a handgun owner does not anticipate any need to access the handgun in a emergency situation. For example, if the handgun owner is leaving the location where handgun locking device 40 is kept for a period of time, cover 42 would be closed and placed in the locked position. Since the handgun owner would not be present, there would be no need to access the handgun. With cover 42 closed and in the locked position, any intruder noticing handgun locking device 40 may not immediately perceive that it contains a handgun, as no portion of the handgun is visible. When the handgun owner knows there is a possibility that a handgun secured by handgun locking device 40 might be needed during a potential emergency situation, the handgun owner may choose to unlock key-actuated lock 44 and open cover 42. A handgun 50 is still securely locked by a keypad 52 locking means, similar to that described with respect to FIG. 1, even when the cover is in its open position. It should be stressed that locking cover 42 closed is not intended to prevent unauthorized access to the handgun, since the cover can likely be readily pried open or the key-actuated lock broken. However, unauthorized access of the handgun, once the cover has been thus improperly opened, will not be readily achieved, because handgun 50 is secure within locking device 40.

Apart from separately lockable cover 42 and the reversed position of handgun 50 within the locking device compared to the position of handgun 16 within handgun locking device 10, handgun locking device 40 is quite similar to handgun locking device 10. Handgun 50 is placed within an opening 48 formed in a plate 47, which comprises an upper surface of a housing 41. A locking member 45 is moved to a locked position behind a trigger (not shown) of handgun 50. Again, the disposition of the locking member behind the trigger prevents handgun 50 from being removed from housing 41, as well as preventing the handgun from being fired while in the locked position. When a proper combination is entered into keypad 52, locking member 45 is enabled to move to an unlocked position, so that handgun 50 can be removed from handgun locking device 40. A lip 46 extends upwardly from housing 41 sufficiently high to prevent access to an ammunition clip 63 within a butt of the handle of handgun 50. As described with respect to FIG. 1, a latch can be accessed to enable plate 47 to be pivoted open (or removed from the housing) only when handgun 50 has been unlocked and removed from handgun locking device 40. With plate 47 in its open position or removed, access to the interior of housing 41 is enabled. As described above, an ammunition storage area and mounting holes (neither shown) within the interior of housing 41 will only be accessible once the handgun has been removed and the plate pivoted open or removed.

Handgun locking device 40 incorporates an additional feature that was not illustrated with respect to handgun locking device 10, but may optionally be included therein. A manual locking lever 54 is shown disposed in and extending above a slot 55 in plate 47. Manual locking lever 54 is used to manually move locking member 45 from an unlocked position to a locked position. Thus, handgun 50 is inserted into opening 48, and manual locking lever 54 is moved to position locking member 45 behind a trigger (not shown) of handgun 50. The locking member is latched in the locked position behind the trigger, preventing handgun 50 from being removed or the trigger depressed, until the proper combination has been entered into keypad 52.

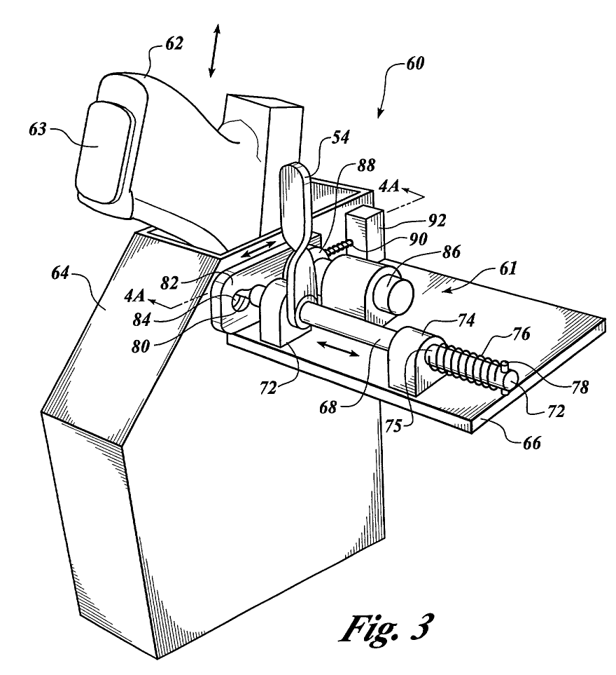

Details on preferred embodiments of the mechanism that is activated by either keypad 34 of FIG. 1 or keypad 52 of FIG. 2 and employed for translating the locking member between a locked and an unlocked position, are provided in FIGS. 3, 4A-4D, FIG. 6, and FIG. 7. Unlocking of the locking member occurs in response to entry by the user of the predefined sequence of keystrokes comprising the proper combination.

FIG. 3 illustrates an assembly 60 used in a preferred embodiment of a handgun support 64 and a locking mechanism 61 that can be used with either of the embodiments described in regard to FIGS. 1 and 2 (but which must be reversed when used with the embodiment of FIG. 1). A handgun 62 is illustrated inserted into handgun support 64. A support plate 66 is either attached to handgun support 64, or formed into the structure of handgun support 64. Support plate 66 serves for mounting and supporting locking mechanism 61. A locking member 68 is supported by brackets 72 and 74. Brackets 72 and 74 each include an orifice 75 that slidably supports locking member 68 (the orifice through bracket 72 is not shown). Locking member 68 must be free to slide through these orifices in brackets 72 and 74, and the orifices are slightly larger than locking member 68 to allow for the free movement of the locking member. Those of ordinary skill in the art will appreciate that bushings or bearings may be incorporated into the orifices of brackets 72 and 74, however such items are not structurally required.

A spring stop 78 is disposed on one end of locking member 68, and secures a locking member return spring 76. As illustrated in FIG. 3, locking member 68 is in a locked position, and locking member return spring 76 is in a compressed state. Once a latch 82 moves from a latched position to an unlatched position, the bias force exerted by locking member return spring 76 will cause locking member 68 to move from a locked position to an unlocked position. As discussed in relation to FIG. 2, locking member 68 is moved from the unlocked position to the locked position by using manual locking lever 54.

Locking member 68 incorporates a notch 80, where the diameter of the locking member is reduced, while latch 82 incorporates a key way 84 through which the locking member extends. Key way 84 is shaped like a keyhole and has a first area (the larger portion of the keyhole shape) sized such that locking member 68 is free to move through key way 84, and a second area (the smaller portion of the keyhole shape) sized to correspond with the diameter of notch 80. When latch 82 is in the closed position, the smaller second area of key way 84 in contact with the shoulders of locking member 68 where notch 80 is formed prevents the locking member from moving.

Latch 82 moves back and forth between its latched position as shown in FIG. 3, and its unlatched position (not shown). A latch spring 90 biases latch 82 toward the latched position. Latch spring 90 is disposed between a latch spring stop 92 and latch 82. To remove handgun 62 from handgun support 64, a proper combination needs to be entered into the keypad of FIG. 1 or FIG. 2. Once the proper combination has been entered, the keypad sends a signal to a rotating solenoid 86. As an alternative to rotating solenoid 86, an electric stepping motor can be used to rotate a disk 88.

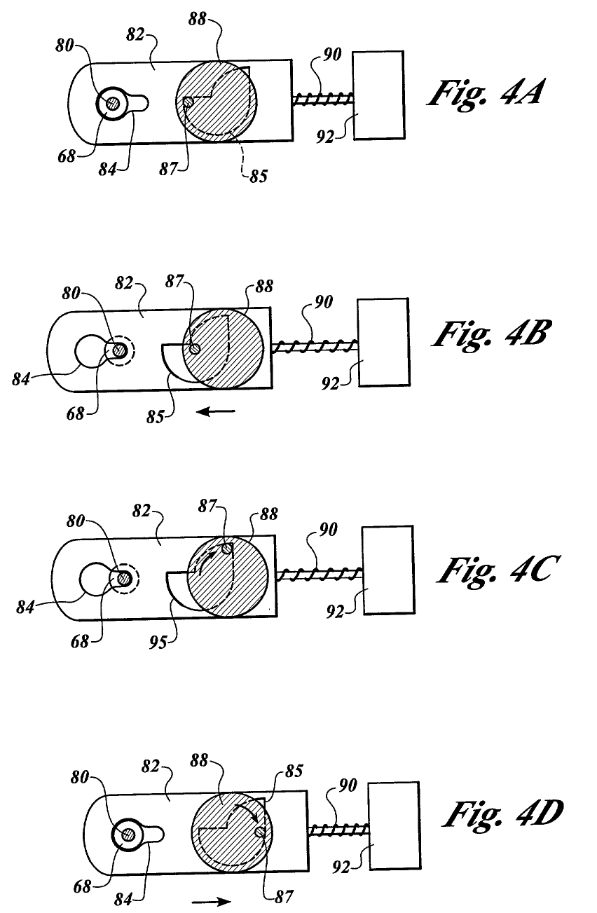

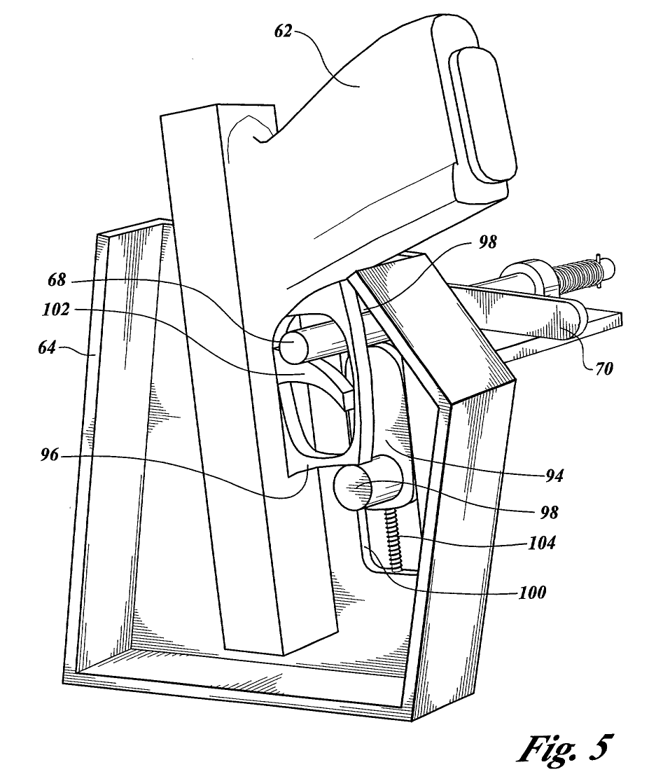

Reference is now made to FIGS. 4A-4D, as well as FIG. 3. When activated, rotating solenoid 86 rotates a disk 88, which is mounted on the end of the shaft of rotating solenoid 86 closest to latch 82. As disk 88 rotates, a pin 87, which fits into a latch cam cut out 85 on latch 82, moves in a circle. Movement of pin 87 engages different portions of latch cam cut out 85 and causes latch 82 to move from its latched position to its unlatched position. When latch 82 is in its unlatched position, latch spring 90 is compressed, and locking member 68 is free to move through the larger first area of key way 84. Locking member return spring 76 biases locking member 68 to move from its locked position to its unlocked position. As soon as locking member 68 and notch 80 are no longer aligned with the smaller second area of key way 84, latch 82 cannot be moved from the unlatched position to the latched position even though latch spring 90 biases catch 82 to the latched position. When locking member 68 is moved to its unlocked position by locking member spring 76, locking member 68 no longer prevents handgun 62 from being removed from support 64, and a user can readily withdraw the handgun from the support.

Further details of the unlocking operation are as follows. In FIG. 4A, latch 82 is in its unlatched position, and latch spring 90 is compressed. Locking member 68 is in its unlocked position, such that notch 80 of locking member 68 is not aligned with key way 84. Thus, locking member 68 prevents latch 82 from moving into its latched position, even though latch spring 90 is compressed. In FIG. 4B, locking member 68 has been moved into its locked position (using manual locking lever 54 as described above), such that notch 80 is aligned with key way 84. Latch spring 90 then expands, driving latch 82 from its unlatched position into its latched position. In FIG. 4C, locking member 68 is in its locked position and latch 82 is in its latched position. After the proper combination has been entered into the keypad of the combination lock, rotating solenoid 86 is actuated, causing disk 88 and pin 87 to move in a circle. Pin 87 has moved from a 9o'clock position in FIGS. 4A and 4B, to a 12o'clock position in FIG. 4C. This movement through 90 degrees positions pin 87 within latch cam cut out 85 so that the pin is able to move the latch toward the right as the pin continues around in a clockwise circle. In FIG. 4D rotating solenoid 86 has continued to move through another 90 degrees, and pin 87 is now in the 3o'clock position, having exerted a force on latch cam cut out 85 that has caused latch 82 to move laterally to the right (as shown in the Figure), from its latched position to its unlatched position. Latch spring 90 is now compressed, and locking member 68 can pass freely through the larger first area of key way 84 from its locked position to its unlocked position in response to the biasing force of locking spring 76.

To lock handgun 62 so that its unauthorized use is prevented, the handgun is placed into support 64. When handgun 62 is properly positioned in support 64, manual locking lever 54 is gripped by the user's hand and shifted to the left (relative to the view in FIG. 2) to move locking member 68 from its unlocked position to its locked position. When in its locked position, notch 80 is aligned with key way 84, and latch spring 90 provides a biasing force as it expands, causing latch 82 to move from its unlatched position to its latched position. At this point, handgun 62 is locked in the support, and cannot be removed until the signal is sent from the combination lock to rotating solenoid 86. Such a signal is generated when the proper combination has been entered using the keypad of FIG. 1 or FIG. 2.

FIG. 5 illustrates further interior details of handgun support 64, making clear how handgun 62 is secured within handgun support 64 and ejected, once the combination lock is opened. Handgun support 64 includes an ejection slide 94 that moved downwardly as handgun 62 is inserted into and locked within handgun support 64, because a trigger guard 96 on the handgun contacts a post 98 that extends outwardly from ejection slide 94. As handgun 62 is pushed further into handgun support 64, ejection slide 94 is pushed downwardly by the interaction of the trigger guard and the protrusion, thus compressing ejection slide spring 104.

In addition to urging the handgun out of the support after the combination lock has been unlocked, ejection slide 94 ensures that locking member 68 does not become positioned in front of a trigger 102. If ejection slide 94 were not included, a user might only partially insert handgun 62 into handgun support 64, and then use manual locking lever 70 to move locking member 68 from an unlocked position to a locked position with locking member 68 disposed in front of trigger 102. In this case, attempting to insert handgun 62 further into the housing could cause locking member 68 to exert a force on trigger 102 that moves the trigger to its firing position, possibly causing an accidental discharge of handgun 62. To prevent this problem from occurring, ejection slide 94 blocks locking member 68 from being moved into handgun support 64 (using manual locking lever 70) until handgun 62 has been inserted sufficiently far into handgun support 64 to ensure that locking member 68 moves behind trigger 102 and not in front of the trigger. When the proper combination has been entered on the combination lock keypad, and the locking mechanism is actuated to open, as discussed above, locking member 68 is returned to its unlocked position, and handgun 62 can be removed from handgun support 64. At that point, ejection slide spring 104 applies a biasing force that moves ejection slide 94 to a home position. It is envisioned that ejection slide spring 104 can be selected to be sufficiently strong so that when locking member 68 is removed from behind trigger 102, that ejection slide spring 104 will at least partially eject handgun 62 from handgun support 64 (into the grip of the user, who might have a hand ready above the handle of the handgun). Alternately, the spring can be chosen to be strong enough to only return ejection slide 94 to its home position, as handgun 62 is removed from handgun support 64. Handgun support 64 includes a channel 100 within which ejection slide 94 moves up and down.

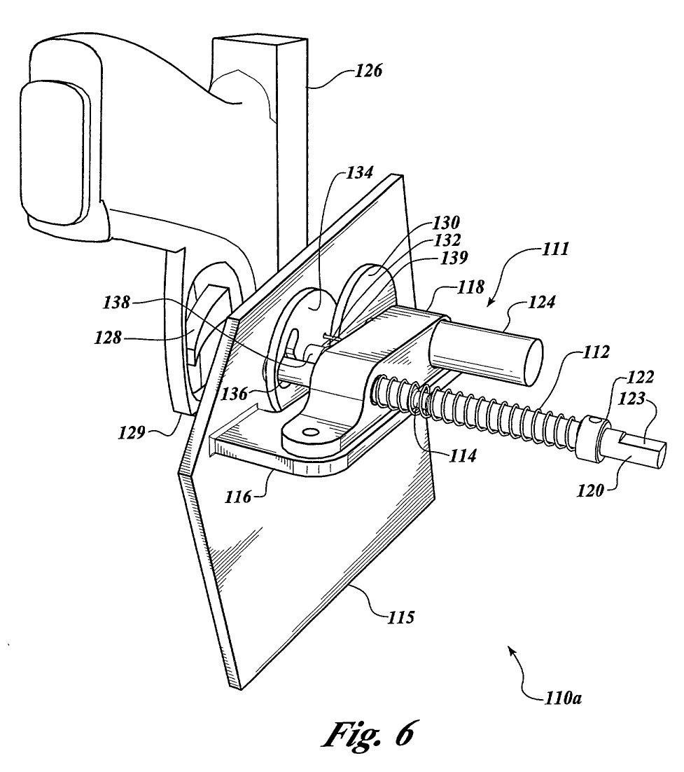

FIGS. 6, 7, and 8 illustrate an alternate embodiment of a locking mechanism that is similar to the embodiment of FIGS. 3 and 5. FIG. 6 shows details of locking apparatus 110a in which a locking mechanism 111 is in its unlocked position. A handgun 126 is illustrated in a position in which it has not yet been fully inserted into a handgun support (note that in this view, only a panel 115 of the handgun support is visible). It should be understood however that the handgun support is generally similar to handgun support 64 in FIG. 3. Handgun 126 includes a trigger guard 129 and a trigger 128. A support plate 116 is either attached to, or formed as part of panel 115. A locking member 120 is shown in its unlocked position, and a notch 114 (having a reduced diameter) can be clearly seen on locking member 120. In this embodiment, a single bracket 118 is mounted to support 116. Bracket 118 supports both locking member 120 and a rotating solenoid 124. A spring stop 122 is mounted on locking member 120, and a locking member return spring 112 is also mounted on locking member 120 and disposed between bracket 118 and spring stop 122. While not shown in this embodiment, it should be noted that a manual locking lever similar to that illustrated in FIG. 3 is preferably connected to locking member 120 (i.e., on a flat 123 formed on the end of the locking member) and is used to move locking member 120 from its unlocked position to its locked position, i.e., to the right as shown in this Figure. Such movement compresses locking member return spring 112, so that when the locking mechanism is unlocked and a latch 134 moves form a latched position to an unlatched position, locking member return spring 112 causes locking member 120 to move from its locked position to its unlocked position. As shown in this Figure, latch 134 is in its unlatched position. Locking member 120 passes through an enlarged portion of a key way 136 or keyhole-shaped opening that is formed within latch 134. A latch spring 132 biases latch 134 to rotate to its latched position on a latch shaft 138, which is mounted to bracket 118. Because notch 114 is not lined up with key way 136, the latch is held in its unlatched position.

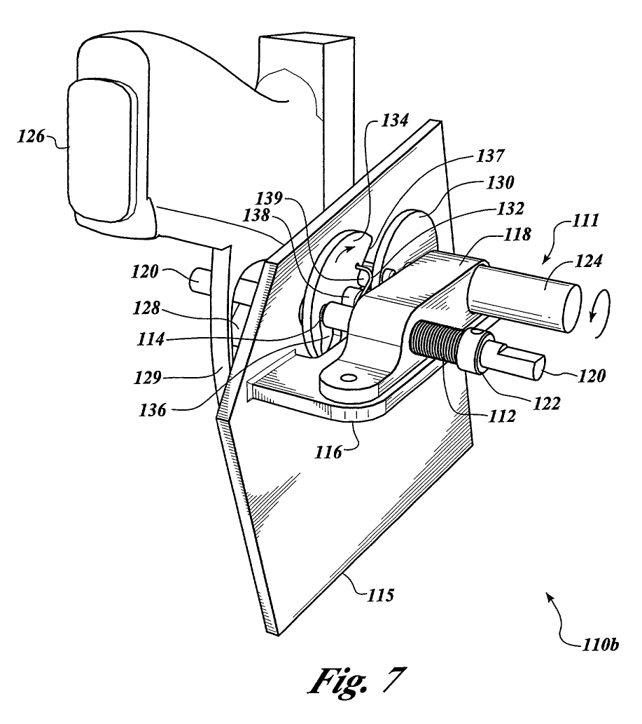

Referring now to FIG. 7, it will be apparent that a rotating solenoid 124 is connected to a cam 130, which includes a cam post 139. Cam post 139 is disposed in a slot 137 on latch 134. In FIG. 7, when rotating solenoid 124 is actuated, cam 130 is caused to rotate counter clockwise (as shown by the arrow to the right of rotating solenoid 124d). Cam post 139 interacts with latch slot 137, moving latch 134 from its latched position to its unlatched position. Locking member 120 is shown in a locked position, with locking member return spring 112 compressed. Notch 114 is aligned with key way 136 in latch 134, but latch spring 132 provides a biasing force that tends to move latch 134 from its latched position to its unlatched position. As the shoulders on each side of notch 114 in locking member 120 cannot pass through the smaller portion of key way 136, locking member 120 is held in the locked position until latch 134 is moved from its latched to its unlatched position. Handgun 126 is thus securely retained within the handgun support structure (of which only panel 115 is shown), and locking member 120 is disposed behind trigger 128.

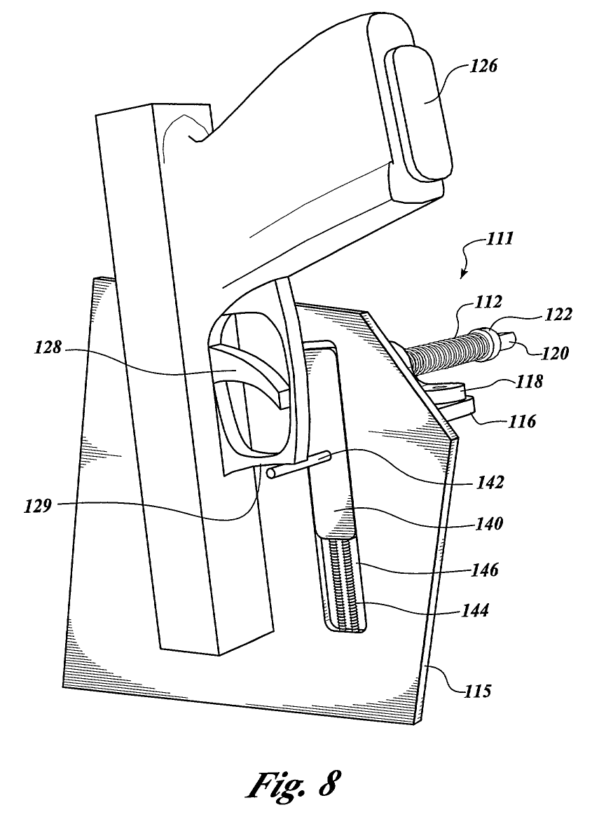

FIG. 8 illustrates the operation of an ejection slide 140, which is used in conjunction with locking mechanism 111 described with respect to FIGS. 6 and 7. Again, as previously noted with respect to FIGS. 6 and 7, only panel 115 of the handgun support structure is shown. Panel 115 includes a slot 146 in which ejection slide 140 can freely move up and down. Ejection slide springs 144 bias ejection slide 140 such that ejection slide 140 is disposed in the upper portion of slot 146 when ejection slide springs 144 are not compressed. On the opposite side of panel 115, support 116, bracket 118, locking member 120, locking member return spring 112, and spring stop 122 can be seen. Note that locking member 120 is in the unlocked position, and ejection slide 140 prevents locking member 120 from being moved into the locked position with the handgun positioned as shown. However, as handgun 126 is inserted into the handgun support, trigger guard 129 engages an ejection slide post 142. As handgun 126 is inserted further into the handgun support, trigger guard 129 forces ejection slide post 142 downwardly, thus compressing ejection slide springs 144 and causing ejection slide 140 to move downwardly within slot 146. Once handgun 126 has been fully inserted into the handgun support, ejection slide 140 is seated at the bottom of slot 146 and ejection slide springs 144 are compressed. In this position, locking member 120 is no longer prevented from passing through slot 146 of panel 115 by the ejection slide. Because handgun 126 has been fully inserted into the handgun support housing, when locking member 120 is moved from the unlocked position to the locked position, locking member 120 will pass behind trigger 128, and not in front of the trigger. Thus, ejection slide 140 prevents the possible positioning of locking member 120 in front of trigger 128, which could cause handgun 126 to be accidentally discharged while in the handgun support structure.

FIGS. 9-13 illustrate a preferred embodiment of a handgun locking device 150 in accord with the present invention, which is designed to be preferably mounted on a vertical surface. Handgun locking device 150 is preferably sized such that the device can fit within a wall between the studs that are used to frame the wall. Alternately, handgun locking device 150 can be securely attached to a surface of a wall, rather than being recessed within the wall between the studs. Included are a housing 152, a cover 154 (that is pivotally attached to housing 152 using hinges 156), and a key-actuated lock 158, which can be used to secure cover 154 to housing 152. It is important to note that key lock 158 is not the primary locking mechanism that will secure a handgun within handgun locking device 150, but is instead simply provided to keep the cover closed, preventing casual inspection of the contents of the locking device. During times when a handgun owner anticipates the need to rapidly access a handgun secured within handgun locking device 150, it is envisioned that the handgun owner would unlock key-actuated lock 158, so that cover 154 could be immediately opened to gain access to the handgun within handgun locking device 150.

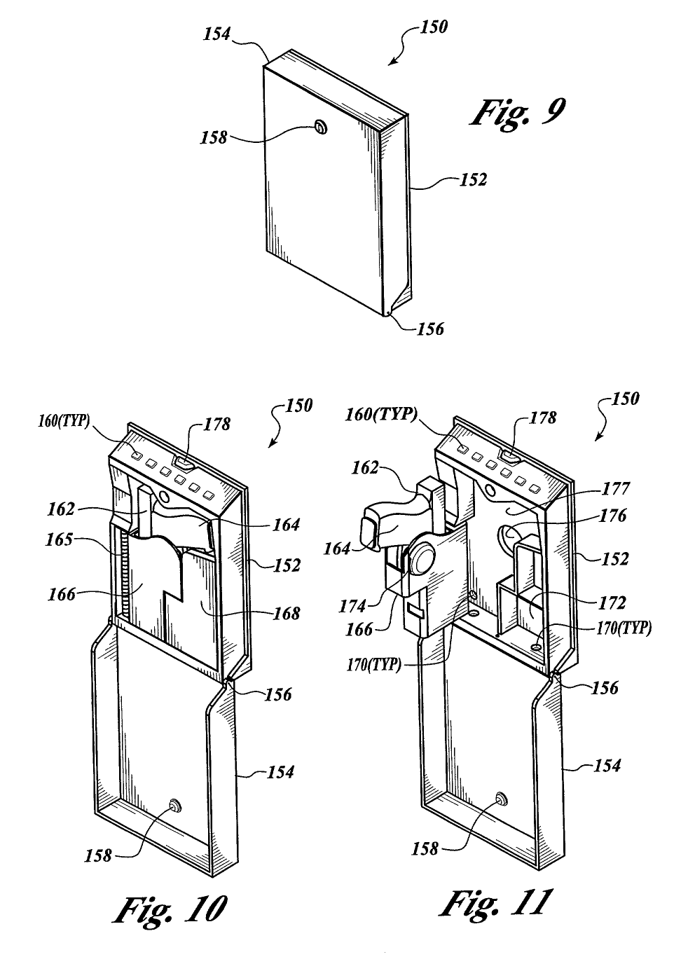

FIG. 10 illustrates an interior view of handgun locking device 150, after cover 154 has been opened. With cover 154 in the open position, a plurality of buttons 160 comprising a combination lock are visible on the upper internal panel surface in housing 152. When these buttons are actuated in a predefined sequence, the combination lock is opened and the handgun can be removed from handgun locking device 150. As discussed above, with respect to the embodiments mounted on a horizontal surface, it is expected that a handgun owner may wish to gain access to a handgun in a dark environment. Thus, it is anticipated that buttons 160 will be lighted or lighted in response to a switch, to facilitate manipulation of the buttons in a darkened room. Similarly, it is anticipated that in a night mode the handgun owner will pre-enter a part of the predefined sequence of buttons comprising the proper combination, such that only a minimal number of button manipulations (e.g., two buttons) to complete the predefined sequence would be required to gain access to the handgun. Once the proper combination has been entered using buttons 160, a handgun release button 178 is enabled. If handgun release button 178 has thus been enabled and is depressed, the handgun can be removed, as will be further described below.

As shown in FIG. 10, a handgun 162 is held in a holster 166 within handgun locking device 150. Holster 166 is shown in a locked position in this Figure, within the interior cavity defined by the housing, such that a handle 164 of handgun 162 is not accessible, and handgun 162 cannot be removed from holster 166 or from handgun locking device 150. An ammunition door 168 is also shown in a closed position. FIG. 11 illustrates handgun locking device 150 after a user has entered the proper combination using the plurality of buttons 160, and release button 178 has been depressed. Holster 166 has pivoted outwardly, in an unlocked position, allowing a user immediate access to grip handgun handle 164. Once holster 166 is in its unlocked position, as illustrated in this Figure, handgun 162 can be immediately removed from handgun locking device 150. In FIG. 11, ammunition door 168 is removed to more clearly show an ammunition storage area 172 provided within housing 152. It is envisioned that ammunition door 168 can include a latch mounted such that the latch is inaccessible when holster 166 is in its locked position. Thus, ammunition door 168 cannot be opened unless a proper combination has been entered using buttons 160, release button 178 has been actuated, and holster 166 has been pivoted outwardly. It is also envisioned that holster 166 can be fabricated so that ammunition door 168 is held shut by holster 166 when the holster is in its locked position, such that ammunition storage area 172 is inaccessible, and when holster 166 is in the unlocked position, ammunition storage area 172 is accessible. As a still further alternative, the ammunition door could be integral with the outer surface of the holster, providing immediate access to ammunition storage area 172 as soon as the holster is pivoted outward in its unlocked position.

Preferably holster 166 is fabricated from a durable material, such that the handgun cannot be accessed by breaking the holster using impact or with a pry bar. Preferably, the holster includes an insert that is specifically sized and shaped to receive the handgun that will be stored within the holster. Such an insert can be fabricated of an elastomeric material that accepts a particular model of handgun, but is more preferably fabricated from an elastomeric or resilient material that can conform to a variety of different models of handguns of a similar type or shape. Different inserts can be fabricated from a polymer material, each having a size and shape to accommodate a plurality of different makes and models of handguns that are of similar size and shape. It is likely that only three or four different inserts would be sufficient to accommodate most of the handguns that might be stored in the handgun locking device.

A plurality of mounting holes 170 are provided within the interior of housing 152, on its inner back surface. As discussed above with respect to the embodiments intended to be mounted on a horizontal surface, access to these mounting holes is preferably only possible when holster 166 has been moved to its unlocked position, thereby preventing the handgun locking device from being removed from a vertical surface to which it is mounted unless the combination lock has been opened to enable the holster to be moved into its open position.

A hole 176 can be seen within an interior wall 177 of housing 152. While not shown in this Figure, it should be understood that release button 178 is operatively connected to the locking mechanism, which is disposed between interior wall 177 and the exterior of housing 152. A locking disk 174 is incorporated into a back surface of holster 166. When holster 166 is moved into its locked position, locking disk 174 passes through hole 176 and engages the locking mechanism disposed behind interior wall 177. Further details of this locking mechanism are described below. It should be noted that the periphery of the rear surface of locking disk 174 is filleted and tapered to more readily engage the locking mechanism as the holster is swung into its locked position.

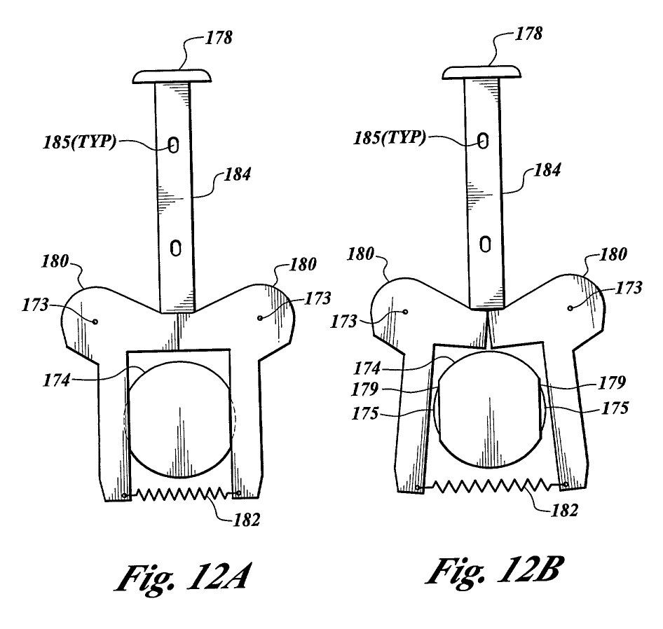

FIGS. 12A and 12B show details illustrating how the locking mechanism disposed behind interior wall 177 operates. Release button 178 is connected to locking members 180 via a shaft 184. In the locked position, shown in FIG. 12A, the arms of locking members 180 are firmly engaged behind shoulders 175 of locking disk 174. A spring 182 attached to both locking members 180 biases them toward each other. Note that locking disk 174 has two flat areas 179, inset from shoulders 175, and that the shoulders engage locking members 180. The filleted or tapered rear surface of the locking disk forces the locking members apart, against the force provided by spring 182, as holster 166 is swiveled into its locked position, and locking members 180 then drop onto flat areas 179 behind shoulders 175. When locking members 180 have engaged these shoulders, locking disk 174 is prevented from moving through hole 176, and holster 166 cannot be moved from its locked position to its unlocked position.

It should be noted that shaft 184 incorporates a plurality holes 185. It is envisioned that locking pins (not shown) will be inserted into one or more of holes 185, when the locking mechanism (also not shown) is in the locked position. When the proper sequence of buttons are manipulated to unlock the combination lock, the locking mechanism will withdraw the locking pins from the shaft, so that release button 178 can then be depressed. Those of ordinary skill in the art will readily recognize that suitable combination locks useful to selectively move locking pins from one position (within holes 185) to a second position (withdrawn from holes 185) are well known and readily available. Accordingly, it is not necessary to show the details of such a combination lock.

When release button 178 is depressed, shaft 184 moves downwardly, exerting a force on locking members 180 that causes the locking members to pivot apart from each other about pivot pins 173, thus releasing locking disk 174. Holster 166 is now pivoted outward from its locked position to its unlocked position by torsion springs 165 (just visible in FIG. 10). Once release button 178 is released, spring 182 draws locking members 180 toward each other, thus urging shaft 184 and release button 178 to return to their original positions before the user depressed the release button.

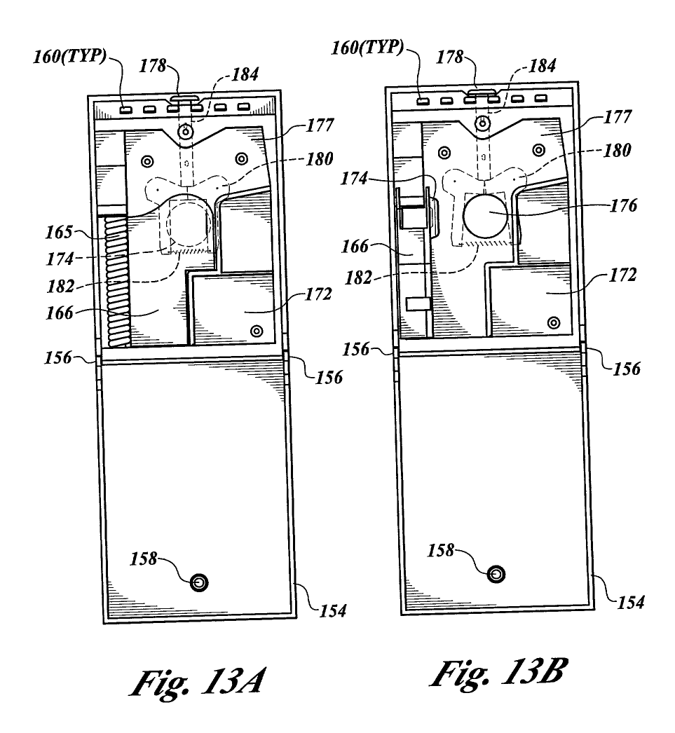

FIGS. 13A and 13B illustrate the disposition of the locking mechanism of FIGS. 12A and 12B within the housing. In FIG. 13A, holster 166 is in its locked position, and locking member 180 prevents locking disk 174 from moving through hole 176, thus preventing holster 166 from being moved to its unlocked position.

In FIG. 13B, the proper sequence of buttons have been pushed, and release button 178 has been depressed. Shaft 184 has moved downward, exerting a force on locking members 180. The locking members have been forced to pivot apart from each other, enabling locking disk 174 to pass freely through hole 176. Torsion springs 165 have pivoted holster 166 outwardly from its locked position to its unlocked position, and a handgun disposed within holster 166 can be immediately gripped by a user and removed.

Holster 166 and the holsters in each of the embodiments disclosed herein are preferably fabricated of steel, a polymer, or a composite of sufficient strength and thickness so that the holster will not be functionally damaged when impacted by a slug fired from a handgun. The intent is again to prevent unauthorized access of the handgun secured by the present invention as a result of damage caused by a party firing a slug from another handgun at the holster assembly.

Although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but instead be determined entirely by reference to the claims that follow.

The invention in which an exclusive right is claimed is defined by the following:

1. A locking device for a handgun, comprising:
(a) a housing having an interior cavity;
(b) a handgun support secured within said interior cavity, said support having an opening adapted to receive a handgun that is inserted into the handgun support, such that a handle of the handgun is accessible, and such that a trigger mechanism and a barrel of a handgun are inaccessible within the handgun support;
(c) a locking member positioned within the interior cavity, the locking member being selectively movable between a locked position that prevents the handgun from being withdrawn from the handgun support, and an unlocked position that enables the handgun to be withdrawn from the handgun support; and
(d) a combination lock disposed within the housing and coupled to the locking member, said combination lock preventing said locking member from being moved from said locked position to said unlocked position until a proper combination is entered in the combination lock.

2. The locking device of claim 1, wherein the combination lock includes a keypad, and the proper combination comprises a predefined sequence of keystrokes.

3. The locking device of claim 2, wherein the keypad is selectively operated in one of a night mode and a day mode, the day mode requiring that all of the predefined sequence of keystrokes be entered within a predetermined time period to enable the locking member to be moved to the unlocked position, and the night mode requiring that a first portion of the predefined sequence of keystrokes be entered when the night mode is selected, and then a remaining portion of the predefined sequence of keystrokes be entered at a later time, to enable the locking member to be moved to the unlocked position.

4. The locking device of claim 3, wherein the night mode reverts to the day mode after a predetermined time interval has elapsed.

5. The locking device of claim 2, wherein the first portion of the predefined sequence of keystrokes comprises all but two keystrokes of the predefined sequence, such that only two remaining keystrokes of the predefined sequence must be entered to enable the locking member to be moved to the unlocked position.

6. The locking device of claim 1, wherein the combination lock comprises a bio-metric sensor, and the proper combination comprises a biological characteristic of a person.

7. The locking device of claim 6, wherein the biological characteristic is one of a fingerprint, a palm print, and a hand print.

8. The locking device of claim 1, wherein the combination lock comprises:
(a) a latch that is selectively movable between a latched position and an unlatched position, and when in the latched position, prevents said locking member from being moved from said locked position to said unlocked position, and when in the unlatched position, enables said locking member to be moved to said unlocked position;
(b) a spring element that biases said latch toward the latched position; and
(c) a rotating driver connected to the latch, such that when the proper combination is entered, the rotating driver moves the latch from the latched position to the unlatched position.

9. The locking device of claim 8, wherein the latch includes an orifice, and wherein the locking member comprises:
(a) an elongate bar having a first cross-sectional area and a notched portion having a second, smaller cross-sectional area, said notched portion being adapted to engage the latch in the latched position, and said first cross-sectional area being adapted to pass through the orifice in said latch when said latch is in said unlatched position; and
(b) a lever operatively connected to the locking member, a portion of the lever projecting outside of said housing so as to be gripped by a user, so that after said handgun has been placed into said handgun support, the lever is manually manipulatable by the user to move said locking member from said unlocked position to said locked position, thereby causing said notched portion to engage said latch to secure the handgun within the handgun support.

10. The locking device of claim 8, further comprising an electrically powered actuator to drive the rotating driver; and a battery power source coupled to said electrically powered actuator to supply an electrical current thereto.

11. The locking device of claim 8, further comprising an electrically powered actuator to drive the rotating driver, said electrically powered actuator being adapted to be energized by an external electrical power source.

12. The locking device of claim 1, wherein the locking member comprises a spring element that is compressed when said locking member is in said locked position, such that when said combination lock is unlocked and said locking member is no longer prevented from moving from said locked position to said unlocked position, said spring element applies a biasing force that automatically moves said locking member to said unlocked position, thereby enabling removal of the handgun from the handgun support by a user.

13. The locking device of claim 1, wherein the locking member is adapted to be disposed behind the trigger of said handgun when in said locked position, thus preventing the trigger from being moved to a firing position, as well as preventing the handgun from being removed from said handgun support.

14. The locking device of claim 13, wherein the locking member is significantly stronger than a trigger, such that any attempt to forcibly remove said handgun from the locking device when said locking member is in said locked position is likely to destroy the trigger.

15. The locking device of claim 13, wherein said handgun support comprises an ejection slide that in a first position prevents said locking member from moving between said unlocked position and said locked position, and a second position that enables said locking member to move to said locked position, the ejection slide being adapted to engage a trigger guard of the handgun, such that the ejection slide moves from the first position to the second position as the handgun is fully inserted within said handgun support.

16. The locking device of claim 15, wherein said handgun support further comprises a spring element coupled to said ejection slide, the spring element exerting a biasing force against said ejection slide that automatically returns said ejection slide to said first position when:
(a) said combination lock is unlocked;
(b) said locking member is moved from said locked position to said unlocked position; and
(c) said handgun is removed from said handgun support.

17. The locking device of claim 15, wherein said handgun support further comprises a spring element coupled to said ejection slide, said spring element exerting a biasing force such that when said combination lock is unlocked and said locking member is moved from said locked position to said unlocked position, the biasing force is sufficient to move said ejection slide from said second position to said first position, thereby being adapted to at least partially eject a handgun from within said handgun support, to position a handle of the handgun so that the handgun can readily be gripped and removed from the locking device.

18. The locking device of claim 17, wherein the spring element comprises a helically coiled spring.

19. The locking device of claim 1, wherein said interior cavity further comprises an ammunition storage area disposed beneath said handgun support, such that access to said ammunition storage area is prevented when said locking member is in said locked position, but is enabled when said locking member is in said unlocked position.

20. The locking device of claim 1, further comprising a plate that separates said housing into an upper section and a lower section, the plate having an opening generally corresponding to a size and shape of said opening in said handgun support, the plate being moveably connected to said housing and disposed such that when a handgun is positioned within said handgun support, a handle of the handgun is disposed above said plate, and a barrel and a trigger of the handgun are disposed beneath said plate.

21. The locking device of claim 20, wherein when said locking member is in said locked position, movement of said plate relative to said housing is precluded, and when said locking member is in said unlocked position, movement of said plate relative to said housing is enabled, so that said lower section of said housing is accessible by moving the plate relative to the housing.

22. The locking device of claim 20, wherein said plate is hingedly connected to said housing.

23. The locking device of claim 20, wherein said plate is removably connected to said housing.

24. The locking device of claim 1, wherein the housing comprises a material of sufficient strength and thickness to prevent a slug discharged from a handgun from penetrating the housing.

25. The locking device of claim 24, wherein the material comprising the housing is steel.

26. The locking device of claim 24, wherein the material comprising the housing is one of a polymer and a composite.

27. The locking device of claim 1, wherein the handgun support comprises an insert that is sized and shaped to receive a handgun.

28. The locking device of claim 27, wherein the insert is fabricated from an elastomeric material that conforms to a size and a shape of a handgun.

29. The locking device of claim 27, wherein the insert is fabricated from a polymer and is sized and shaped to receive any member of a group of handguns that are of a similar size and shape.

30. The locking device of claim 1, wherein the interior cavity further comprises at least one mounting hole, said at least one mounting hole being disposed to be inaccessible when a handgun is secured in the locking device, and to be accessible only when the handgun is removed from the locking device.

31. The locking device of claim 1, wherein said housing further comprises a lip disposed and shaped to prevent an ammunition clip from being removed from a handle of a handgun that is secured within the locking device.

32. The locking device of claim 1, wherein the housing includes a cover movable between a closed position and an open position, said cover, when in a closed position, concealing a handle of a handgun secured in the locking device, and when in an open position, said cover exposing the handle of the handgun.

33. The locking device of claim 32, wherein said cover is hingedly coupled to a portion of said housing.

34. The locking device of claim 32, wherein said cover is removably coupled to another portion of said housing.

35. The locking device of claim 32, wherein said cover further comprises a lock that when locked, prevents the cover from being moved from the closed position to the open position.

36. The locking device of claim 35, wherein said lock of the cover comprises a key lock.

37. The locking device of claim 1, further comprising an alarm unit operatively connected to said combination lock and adapted to connect with a remote alarm, said alarm unit being selectively operable in an alarm mode, such that if the alarm unit is in the alarm mode and said combination lock is unlocked, an alarm condition is indicated, and in response to the alarm condition, the alarm unit is adapted to activate the remote alarm, thereby indicating that an emergency has occurred that requires removal of a handgun from the locking device.

38. The locking device of claim 37, wherein said alarm unit is adapted to connect to a home security system, and to use the home security system to activate the remote alarm at a monitoring service that is monitoring the home security system, in response to the alarm condition.

39. The locking device of claim 37, wherein said alarm unit is adapted to connect to a telephone line, and to dial a telephone number of an emergency service to notify the emergency service of the emergency, in response to the alarm condition.

40. The locking device of claim 39, wherein said alarm unit further comprises a voice recording, and in response to the alarm condition, is adapted to transmit the voice recording over the telephone line to the emergency service.

41. A locking system for a handgun, comprising:
(a) a housing having walls defining an interior;
(b) a holster disposed in said interior and movably attached to said housing, said holster being selectively moveable from a first holster position in which a disposition and a fit of the holster within said interior prevents a handgun from being removed from the holster, and a second holster position in which a handle of a handgun is accessible for convenient gripping so that ready removal of a handgun from the holster is enabled;
(c) a locking member disposed within said interior, the locking member being selectively movable between a locking position that prevents the holster from being moved from the first position to the second position, and an unlocked position that enables the holster to be moved from the first position to the second position; and
(d) a combination lock operatively connected to said locking member and having a locked state and an unlocked state, such that when said combination lock is in a locked state, the combination lock prevents said locking member from being moved from said locked position to said unlocked position, until a proper combination is entered by a user to change said combination lock to its unlocked state.

42. The locking system of claim 41, wherein the combination lock comprises a keypad, and wherein the proper combination comprises a predefined sequence of keystrokes entered on the keypad.

43. The locking system of claim 42, wherein the combination lock is selectively operable in one of a night mode and a day mode, the day mode requiring that all of the predefined sequence of keystrokes be entered within a predetermined time period to enable the locking member to be moved to the unlocked position, and the night mode requiring that a first portion of the predefined sequence of keystrokes be entered when the night mode is selected, and then a remaining portion of the predefined sequence of keystrokes be entered at a later time, to enable the locking member to be moved to the unlocked position.

44. The locking system of claim 43, wherein the night mode reverts to the day mode after a predetermined time interval has elapsed.

45. The locking system of claim 43, wherein the first portion of the predefined sequence of keystrokes comprises all but two keystrokes of the predefined sequence, such that only two remaining keystrokes of the predefined sequence must be entered to enable the locking member to be moved to the unlocked position.

46. The locking system of claim 41, wherein the combination lock comprises a bio-metric sensor, and the proper combination comprises biological characteristic of a person.

47. The locking system of claim 46, wherein the biological characteristic is one of a finger print, a palm print, and a hand print.

48. The locking system of claim 41, further comprising a spring element that is:
(a) disposed within said interior;
(b) connected to said holster; and
(c) compressed when said holster is in said first holster position, such that when said combination locking means is unlocked and said locking member is not preventing said holster from moving to the second position, a biasing force produced by said spring element automatically moves said holster to the second position.

49. The locking system of claim 48, wherein the spring element comprises a helical spring.

50. The locking system of claim 41, wherein said interior includes an ammunition storage area disposed in relationship to said holster such that access to the ammunition storage area is prevented when said holster is in the first position, but when said holster is in the second position, access to the ammunition storage area is enabled.

51. The locking system of claim 41, further comprising a cover movably connected to said housing so as to move between a closed position and an open position, such that when the cover is in a closed position, access to the interior is prevented, and when the cover is in an open position, access to the interior is enabled.

52. The locking system of claim 51, wherein said housing and said cover comprise a material of sufficient strength and thickness to prevent a slug discharged from a handgun from penetrating the housing or the cover.

53. The locking system of claim 52, wherein the material comprising the housing and the cover is steel.

54. The locking system of claim 52, wherein the material comprising the housing and the cover is one a polymer and a composite.

55. The locking system of claim 41, wherein said holster is fabricated from a durable material of sufficient strength, such that the handgun cannot readily be accessed by breaking said holster.

56. The locking system of claim 41, wherein the holster comprises a material of sufficient strength and thickness to prevent a slug discharged from a handgun from penetrating the housing or the cover.

57. The locking system of claim 41, wherein the holster comprises an insert that is sized and shaped to receive a handgun.

58. The locking system of claim 57, wherein the insert is fabricated from an elastomeric material that conforms to a size and a shape of a handgun.

59. The locking system of claim 57, wherein the insert is fabricated from a polymer and is sized and shaped to receive any member of a group of handguns that are of a similar size and a shape.

60. The locking system of claim 41, wherein the interior comprises at least one mounting hole, said at least one mounting hole being disposed to be inaccessible when said holster is in the first position, and to be accessible when said holster is in the second position.

61. The locking system of claim 51, wherein said cover includes a locking mechanism that when locked, prevents the cover from being moved from the closed position to the open position.

62. The locking system of claim 61, wherein said locking mechanism comprises a key lock.

63. The locking system of claim 41, further comprising an alarm unit operatively connected to said combination lock and adapted to connect with a remote alarm, said alarm unit being selectively operable in an alarm mode, such that if the alarm unit is in the alarm mode and said combination lock is unlocked, an alarm condition is indicated, and in response to the alarm condition, the alarm unit is adapted to activate the remote alarm, thereby indicating that an emergency has occurred that requires removal of a handgun from the locking device.

64. The locking system of claim 63, wherein said alarm unit is adapted to connect to a home security system, and to use the home security system to activate the remote alarm at a monitoring service that is monitoring the home security system, in response to the alarm condition.

65. The locking system of claim 63, wherein said alarm unit is adapted to connect to a telephone line, and to dial a telephone number of an emergency service to notify the emergency service of the emergency, in response to the alarm condition.

66. The locking system of claim 65, wherein said alarm unit further comprises a voice recording, and in response to the alarm condition, is adapted to transmit the voice recording over the telephone line to the emergency service.

67. The locking system of claim 41, wherein the housing is adapted to enable the locking system to be mounted within a wall.

68. A method of securing a handgun against unauthorized access, comprising the steps of:
(a) providing a locking device having a housing that includes a lock and a receiver for a handgun, said receiver being shaped to prevent access to a trigger of a handgun that is inserted into the receiver, while at least a portion of a handle of the handgun is exposed;
(b) placing the handgun within the receiver so that the trigger of the handgun is inaccessible within the receiver; and
(c) locking the handgun within the receiver with the lock so that the handgun is inaccessible until the lock is opened, and so that the trigger cannot be moved to a firing position until the lock is opened.

69. A method of securing a handgun against unauthorized access, comprising the steps of:
(a) providing a housing defining an interior cavity, a lock, and a holster mounted to seat within the interior cavity when in a first position, said interior cavity being sized and shaped to prevent the handgun being removed from the holster until the holster is moved to a second position that is outside the interior cavity and which enables access to and removal of the handgun from the holster;
(b) placing the handgun within the holster while the holster is in the second position;
(c) moving the holster from the second position to the first position; and
(d) locking the lock to secure the holster and the handgun within the interior cavity of the housing, said handgun remaining inaccessible until the lock is unlocked and the holster is moved to its second position.
